(19) United States
(12) Patent Application Publication
(10) Pub. No.: US 2022/0259367 A1
(43) Pub. Date: Aug. 18, 2022

(54) ENGINE AND/OR AGGREGATE CAPSULE

(71) Applicant: ADLER PELZER HOLDING GMBH, Hagen (DE)

(72) Inventors: Frank RIEDERER, Witten (DE); Thomas KRACZ, Dortmund (DE); Volkmar SCHULZE, Schierling (DE); Volker KURSCH, Essen (DE); Andreas HART, Dortmund (DE)

(21) Appl. No.: 17/606,378

(22) PCT Filed: Apr. 21, 2020
(86) PCT No.: PCT/EP2020/061090

§ 371 Date: Oct. 25, 2021

(30) Foreign Application Priority Data
Apr. 23, 2019 (DE) 10 2019 110 463.7

(51) Int. Cl. C08G 18/48; C08G 18/54; F02B 77/13; C08G 18/08

(52) U.S. Cl. CPC C08G 18/4829; C08G 18/542; F02B 77/13; C08G 2101/00; C08G 2110/0058; C08G 2350/00; C08G 18/14

(57) ABSTRACT

Disclosed is an acoustically and thermally effective engine and/or aggregate capsule which completely encloses the engine and/or aggregate.

The object of the invention is an acoustically and thermally effective capsule which completely encloses the engine and/or the aggregate and consists of a sound-insulating carrier layer which is back-foamed with a polyurethane foam and has hinges and closure lugs, and the openings for cables and other connections are surrounded by foam.

To reduce the noise emissions of mechanical, electromechanical or electrical machines, their housings are surrounded by sound insulation capsules. The capsules or sleeves have a sound-absorbing composite material wall, which is provided with a plastic carrier layer as a heavy layer and a sound-absorbing layer as an inner layer in contact with the housing of the machine. Such sleeves or capsules are known, for example, for the sound insulation of electric motors, gearboxes and compressors in vehicles.

After being placed around the housing of the machine, the known sleeves or capsules are held together or in position by means of expanding rivets, screws, plug-in connections, snap fasteners, hook clamps and Velcro and adhesive tapes, among other things. The assembly of such sound insulation is comparatively complex, which consequently involves additional assembly work and costs.

In the prior art, encapsulations are known which are constructed in one or more parts and usually consist of different material combinations. A distinction is often made between encapsulation close to the skin (close-range encapsulation) and encapsulation far from the skin (mid-range encapsulation) and encapsulation following the contour of the vehicle body (vehicle body-shaped encapsulation), for example DE 10 2006 027 230 A1 and DE 10 2012 106 644 A9).

In the case of close-range encapsulations, a further distinction is made between the top cover, the cold (air intake) side, the drive belt (chain) side, the oil pan side, the gearbox side and the hot (exhaust) side.

On the material side, top covers are described, for example, in WO 2016/166196 A1, WO 2016/166217 A1 and WO 2016/166218 A1.

DE 10 2004 022 895 A1 discloses a sheathing element made of thermoplastic material, which is at least partially formed as a hollow body, for shielding the engine and/or the exhaust system of a motor vehicle.

DE 10 2015 108 583 A1 discloses a housing made of PUR foam, in particular of so-called integral skin foam, for encasing components.

DE 10 2015 217 100 A1 and DE 10 2015 205 746 A1 disclose automotive functional components, a thermally insulating and/or sound emission reducing insulation component in which different layers are adhesively bonded by foam adhesive.

General information on thermo-acoustic motor encapsulations can be found at: Mantovani M. et al. ATZ 01/2010, pp. 20-25 and Bürgin, T. et al, ATZ 03/2014, pp. 34-39.

Soft-elastic and viscoelastic polyurethane moulded foams are widely used in the field of vehicle acoustics. Common soft-elastic foams are generally assigned to the “high resilience” type and exhibit a pronounced spring characteristic with spontaneous or rapid recovery behaviour. In contrast to this, viscoelastic foam types are characterized by a delayed recovery behaviour after pressure deformation as an essential distinguishing feature from soft-elastic foam types. In comparison to “high resilience” foams, viscoelastic foams generally achieve significantly better damping properties.

Light foams, usually cut foams and melamine resin foams are also used.

The typical material properties of these foams are primarily determined by the polyol types and additives used, their quantity distribution, the degree of crosslinking and the selected density. With regard to the intended use for acoustically effective spring-mass encapsulations in motor vehicles, but also taking into account high temperatures in combination with humidity conditions, which often lead to premature aging or even hydrolytic material decomposition, either polyester or polyether polyols are used. For current applications, standard foams (FIR foams) are mainly used. Moreover, these standard foams (based on conventional polyether base are less sensitive to hydrolytic decomposition than polyester based types, but not far enough stable to withstand the above strictly modified aging conditions. Basically, high temperatures lead to premature material aging, while dry conditions lead to brittleness and hydrolytic conditions (due to high temperatures in combination with humidity) lead to softening effects, loss of mechanical and acoustic properties or even full permanent material degradation.

In the yet unpublished DE 10 2018 130 184, a polyurethane foam formulation based on polyether and novolac polyols, which are conventional per se, with, in particular, MDI for the production of soft-elastic PUR moulded foams with viscoelastic properties, in particular for sound insulation with foams based thereon, is described.

In the past, little attention was paid to the hydrolysis resistance of known encapsulations for engines and transmissions of motor vehicles. During the development of new moulded foams, the aging weaknesses of the known moulded foams were discovered. The known viscoelastic moulded foams have a typical weakness in compression set. Moreover, compression set is often used as an indicator of material aging, especially caused by hydrolytic processes. Furthermore, hydrolytic conditions lead to general degenerations represented by significantly reduced mechanical properties such as tensile strength, elongation at break and compressive load.

In the yet unpublished DE 10 2018 133 386, a device for sound insulation of a machine is described which comprises a sleeve and a sound-absorbing composite material wall with a synthetic material carrier layer. This is a non-fully enclosing/fully encasing “sleeve” with a novel flap closure as the main feature.

No encapsulations are known from the prior art that describe a fully enclosing engine or aggregate encapsulation consisting of an insulating carrier layer with back-foamed viscoelastic PUR foam.

The task of the present invention in comparison with the aforementioned prior art is thus to provide an engine/aggregate capsule which completely encloses the engine or aggregate; the apertures for cables and other connections are foamed/sealed and the overlap of individual capsule elements is designed/shaped to be soundproof.

### BRIEF DESCRIPTION OF THE DRAWINGS

Further advantages and embodiments will become evident from the attached figures, wherein:

FIG. 1 is a perspective view of a fully enclosing engine capsule in accordance with the present invention;

FIG. 2 is a view similar to FIG. 1, showing details of an embodiment of the present invention;

FIG. 3 shows further details of the present invention;

FIG. 4 shows further details of the present invention; and

FIG. 5 shows further details of the present invention.

In a first embodiment, the object of the present invention is a fully enclosing engine and/or aggregate capsule (1) consisting of a sound-insulating carrier layer (2) which is back-foamed with a PUR foam (3) and has hinges (4) and closure tabs (5), characterized in that the carrier layer (2) consists of a flexible compound having the Shore (A) hardness in the range from 60 to 95, the thickness of which is in the range from 1.2 to 4 mm; the weight per area results, on the one hand, according to the compound density in the range of 1.2 and 3.0 g/cm³ and, on the other hand, from requirement-related, different carrier layer thicknesses (6, 6.1) over the total area (sheathing area);

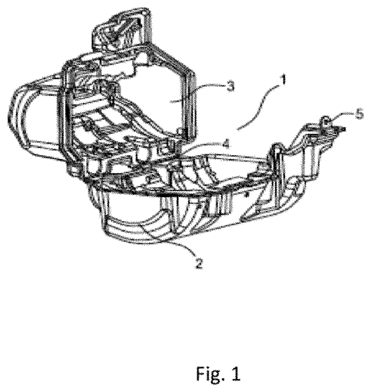

the PUR foam (3) comprising the properties:
density in the range from 45 to 105 g/l, in particular 55 to 85 g/l.
storage module in the range of 20 to 250 kN/m², in particular 40 to 100 kN/m² and
Loss factor 0.3 to 0.8, in particular 0.33 to 0.50,
wherein the polyurethane foam formulation comprises for the preparation of the viscoelastic PUR molded foam:
a) a novolac polyol with a Flydroxyl functionality of 3, a Flydroxyl value in the range 160 to 240 mg KOFI/g
b) a polyether polyol having a Flydroxyl functionality of 3, a Flydroxyl value in the range 20 to 40 mg KOFI/g
c) a block/copolymer having a Flydroxyl value in the range of 25 to 45 mg KOFI/g; and
d) a combination of catalytically active as well as stabilising additives (known per se) (see in particular FIG. 1).

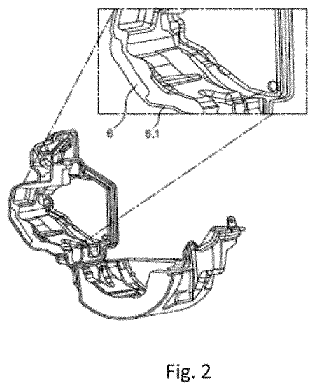

A further embodiment according to the present invention comprises a fully enclosing engine or aggregate capsule (1), which is characterized in that the carrier layer (2) has different carrier layer thicknesses (6, 6.1) over the total surface (sheathing area), which are implemented on the one hand by different gap widths of the injection moulding tool over the total area (sheathing area) and on the other hand by changeable inserts arranged partially over the total area (sheathing area) (see in particular FIG. 2).

A further embodiment is characterized in that fluid-carrying conductions for regulating thermal management are foamed into the PUR foam (3).

The openings in the fully enclosed motor and/or aggregate capsule (1) for cables and other connections are foamed/sealed with the foam (3) (see in particular FIG. 4).

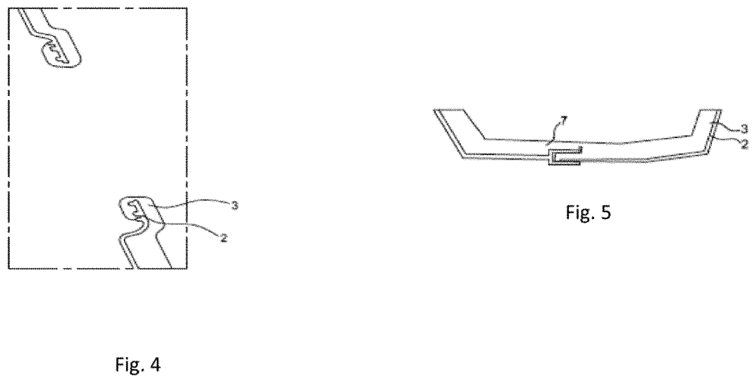

FIG. 5 shows an edge/overlap design (plug-in connection) of the fully enclosing engine and/or aggregate capsule (1) according to the present invention.

In some applications it makes sense to roll the foam (3) after back foaming the carrier layer (2). This breaks up the foam cells and improves the acoustic efficiency of the foam (3); it also makes it softer.

The polyurethane foam formulation according to the present invention is based on a particular material composition which meets the basic viscoelastic acoustic requirements and enables a moulded foam which also meets the new defined standards with regard to hydrolytic aging. The base polyether polyol enables—similar to conventional foam compositions—a basically soft and flexible foam product. The required combination of viscoelastic properties and significantly improved temperature and hydrolysis resistance is achieved by using a highly aromatic Novolac-type polyol, whose molecular structure provides suitable building blocks for hard segments but also strongly supports thermal and hydrolytic stability. The incorporation of Novolac polyols is essential for the present invention, since their actual field of application is rigid polyurethanes.

The carrier layer, of which the closure and overlap design is an integral part, must comprise flexibility (flexural softness). In this respect, it is advantageous if the plastic carrier layer consists of a material whose Shore (A) hardness is in the range from 60 to 95 and in particular in the range from 70 to 85. Suitable plastic materials for the carrier layer (heavy layer) are, for example, EVA/PE, PE, PP, EPDM, TPE, TPO and application-specific compounds.

The core of the present invention is the provision of an acoustically and thermally effective, fully enclosing engine and/or aggregate capsule in which a requirement-related, differently designed weight per area over the carrier layer area, combined with a hydrolysis-resistant, viscoelastic PUR foam and a soundproof capsule element overlap design go hand in hand.

The advantage of the present invention is the combination of the carrier layer, including integrated overlap and closure mechanism, and foam system in such a way that the carrier layer can have weights per area as required; and the foam system is acoustically highly effective, in particular also resistant to hydrolysis; and the openings in the fully enclosed capsule do not represent acoustic leakage points, as does the (form-fitting) edge/overlap design of capsule elements/shells.

### EXAMPLE OF EMBODIMENT

A PP-based compound was used to produce a carrier layer with a basis weight of 3.00 kg/m², uniform over the entire area, and a Shore (A) hardness of 72 by means of injection moulding. This was then back foamed with a soft-adhesive PUR foam, density 85 g/A, storage modulus of 95 kN/m² and a loss factor of 0.5.

After application of the capsule around an aggregate, this was measured on a test stand (Scan&Paint Intensity measurement with the Micro-flown probe).

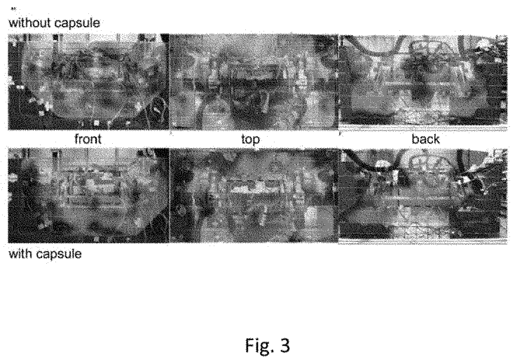

FIG. 3 shows the measurement result: the acoustic effect is clearly visible.

In the Scan&Paint measurement, the Microflown PU probe is used to scan the measurement object. The sound intensity level can be calculated from the measured values and displayed by means of colour coding (red=high level, blue=low level). The pictures show an example of a one-third octave centre frequency.

### REFERENCE LIST

1 capsule
2 Carrier layer
3 Foam
4 Hinge
5 Closing flap
6 Carrier layer thickness
7 Aggregate wall

1. A fully enclosing motor and/or aggregate capsule, comprising a sound-insulating carrier layer, which is back foamed with a PUR foam material, and has hinges and closure tabs, wherein
the carrier layer comprises of a flexible compound having the Shore (A) hardness in the range of 60 to 95, and a thickness in the range of 1.2 to 4 mm;
a weight per area results, on the one hand, according to the compound density in the range of 1.2 and 3.0 g/cm3 and, on the other hand, from requirement-related, different carrier layer thicknesses over the total area (sheathing area);
the PUR foam comprising the properties:
a density in the range from 45 to 105 g/l,
a storage module in the range of 20 to 250 kN/m², and
a Loss factor 0.3 to 0.8, in particular 0.33 to 0.50,
wherein the polyurethane foam formulation comprises for the preparation of the viscoelastic PUR moulded foam:
a) a novolac polyol with a Flydroxyl functionality of 3, and a Flydroxyl value in the range 160 to 240 mg KOFI/g,
b) a polyether polyol having a Flydroxyl functionality of 3, and a Flydroxyl value in the range 20 to 40 mg KOFI/g,
c) a block/copolymer having a Flydroxyl value in the range of 25 to 45 mg KOFI/g; and
d) a combination of catalytic and stabilising additives.

2. The fully enclosing engine and/or aggregate capsule according to claim 1, wherein
the carrier layer has different carrier layer thicknesses over the total area (sheathing area) as a result of the requirements, which are implemented on the one hand by different gap widths of the injection moulding tool over the total area (sheathing area) and on the other hand by changeable inserts arranged partially over the total area (sheathing area).

3. The fully enclosing engine or aggregate capsule according to claim 1, wherein fluid-carrying conductions for regulating thermal management are foamed into the PUR foam.

4. The fully enclosing engine or aggregate capsule according to claim 1, wherein the capsule comprises two hinge-free half-shells.

5. The fully enclosing motor and/or aggregate capsule according to claim 1, wherein the PUR foam has a density in the range from 55 to 85 g/L.

6. The fully enclosing motor and/or aggregate capsule according to claim 1, wherein the PUR foam has a storage module in the range of 40 to 100 kN/m².
